(19) United States
(12) Patent Application Publication
(10) Pub. No.: US 2023/0271192 A1
(43) Pub. Date: Aug. 31, 2023

(54) AGGREGATE PROCESSING APPARATUS, SYSTEMS, AND METHODS

(71) Applicant: Superior Industries, Inc., Morris, MN (US)

(72) Inventors: Danilo Bibancos, Morris, MN (US); John Rodriguez, Morris, MN (US); Lafe Grimm, Morris, MN (US); Matthew Gordon, Morris, MN (US); Mark Crooks, Morris, MN (US); Troy Plattner, Morris, MN (US)

(21) Appl. No.: 18/312,476

(22) Filed: May 4, 2023

Related U.S. Application Data
(63) Continuation of application No. PCT/US2021/072251, filed on Nov. 4, 2021.
(60) Provisional application No. 63/109,513, filed on Nov. 4, 2020.

(51) Int. Cl. B02C 25/00; B02C 23/04; B02C 23/08

(52) U.S. Cl. CPC B02C 25/00; B02C 23/04; B02C 23/08

(57) ABSTRACT

Aggregate processing systems, methods and apparatus are described. Some embodiments include a plurality of equipment criteria sensors, product quantity sensors, product characteristic sensors, and/or actuators. Some embodiments include a control system incorporating algorithm logic. Some embodiments include a control system incorporating artificial intelligence logic.

### BACKGROUND

Aggregate processing apparatus, systems and methods are used to process aggregate material.

### BRIEF DESCRIPTION OF THE DRAWINGS

FIG. 1 schematically illustrates an embodiment of an aggregate processing system.

FIG. 2 schematically illustrates an embodiment of a stationary aggregate processing plant.

FIG. 3 illustrates an embodiment of a vibratory classifier having certain sensors and control elements.

FIG. 4 illustrates an embodiment of a crusher having certain sensors and control elements.

FIG. 5 is a side elevation view of an embodiment of a crusher having certain sensors and control elements.

FIG. 6 is a sectional view along section 6-6 of FIG. 5.

FIG. 7 is a side elevation view of an embodiment of a portable plant.

FIG. 8 illustrates an embodiment of a graphical user interface.

FIG. 9 illustrates an embodiment of a method of controlling and/or monitoring an aggregate processing plant.

FIG. 10 illustrates an embodiment of another method of controlling and/or monitoring an aggregate processing plant.

FIG. 11 illustrates an embodiment of another method of controlling and/or monitoring an aggregate processing plant.

FIG. 12 illustrates an embodiment of a kinetic sensor.

FIG. 13 illustrates an embodiment of a user interface.

FIG. 14 illustrates another embodiment of a user interface.

### DESCRIPTION

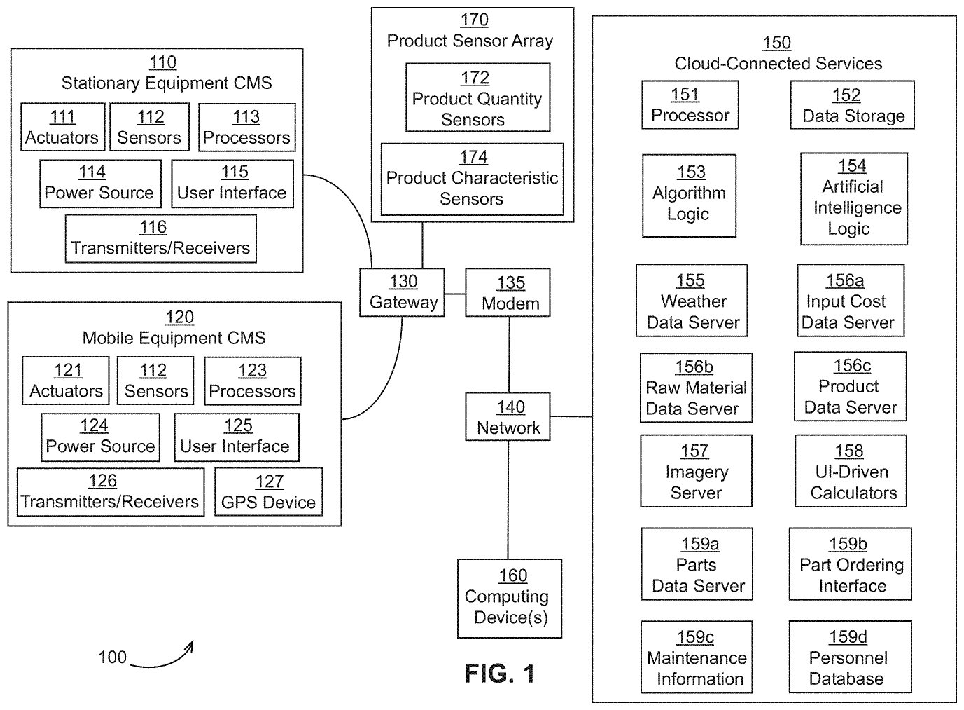

Referring to the drawings, wherein like reference numerals designate identical or corresponding parts throughout the several views, FIG. 1 schematically illustrates an aggregate processing system 100.

In some embodiments, the aggregate processing system 100 includes one or more stationary equipment control and monitoring systems 110 associated with (e.g., supported on and/or in data communication with) one or more units of stationary aggregate processing equipment units such as those described herein. “Aggregate processing equipment” as used herein includes but is not limited to crushers (e.g., jaw crushers, cone crushers, horizontal shaft impactors, vertical shaft impactors, mills, etc.), vibratory classifiers (e.g., horizontal screens, inclined screens, grizzly feeders, etc.), wet processing equipment (dewatering screens, washers, classifying tanks, hydrocyclones, etc.), conveyors (e.g., jump conveyors, stacking conveyors, radial stacking conveyors, tracked conveyors, overland conveyors, truck unloaders, etc.), and/or any stationary, portable or mobile processing plant combining one or more such units of equipment. Each system 110 optionally includes one or more of the following: actuators 111, sensors 112, processors 113, power sources 114, user interfaces 115, and transmitters/receivers 116.

In some embodiments, the aggregate processing system 100 includes one or more mobile equipment control and monitoring systems 120 associated with (e.g., supported on and/or in data communication with) one or more units of mobile aggregate processing equipment units (e.g., plants supported on tracks, wheels, etc.) such as those described herein. Each system 120 optionally includes one or more of the following: actuators 111, sensors 112, processors 113, power sources 114, user interfaces 115, transmitters/receivers 116, and GPS devices 127.

In some embodiments, the aggregate processing system 100 includes one or more product sensor arrays 170 comprising one or more product quantity sensors 172 (e.g., belt scales, fill level sensors, etc.) and/or one or more product characteristic sensors 174 (e.g., cameras, temperature sensors, moisture sensors, distance sensors, fill level sensors, etc.). The product quantity sensors and product characteristic sensors may be associated with mobile or stationary equipment, or with one or more product transfer apparatus (e.g., conveyors, etc.) or product storage arrangements (e.g., stockpile, container, etc.).

In some embodiments, the systems 110, 120 and/or the product sensor array 170 are in data communication with one or more computing devices 160 (e.g., mobile devices, smartphones, tablets, desktop computers, servers, etc.). In some embodiments, the systems 110, 120 and/or the product sensor array 170 are in data communication with the computing devices 160 via a network 140 (e.g., the internet, the cloud, an intranet, one or more server networks, etc.). In some embodiments, the systems 110, 120 and/or the product sensor array 170 are in data communication with the network 140 via a gateway 130 (e.g., wireless router, wireless repeater, wireless transmitter, radio transmitter, LoRaWan gateway, etc.) which may be configured to transmit data over relatively large distances such as greater than 10 feet, greater than 20 feet, greater than 50 feet, or greater than 100 feet. The gateway 130 is optionally in data communication with a modem 135 for transmission of data to network 140.

One or more cloud-connected services 150 are optionally in data communication with the network 140 and/or the computing devices 160. The cloud-connected services 150 optionally include one or more of the following: processor 151, data storage 152, algorithm logic 153, artificial intelligence logic 154 (e.g., machine learning logic, deep learning logic, unsupervised machine learning logic, supervised machine learning logic, etc.), weather data server 155 (e.g., providing location-specific ambient atmospheric information such as temperature, humidity, dew point, altitude, air pressure, precipitation, precipitation amount, precipitation likelihood, etc.), input cost data server 156a (e.g., operable to provide the historical, current, and/or predicted price of resources and other inputs such as fuel, electricity, water, etc.), raw material data server 156b (e.g., operable to provide information such as quantities, qualitative characteristics, geo-referenced locations, etc. of raw materials such as those on the site to be operated), product data server 156c (e.g., operable to provide the historical, current, and/or predicted price of various commodities and/or products to be produced by the system 100, such as sand, gravel, minerals, etc.), and/or imagery server (e.g., aerial image server) 157. The cloud-connected services 150 optionally include one or more calculators 158 for collecting data (e.g., equipment dimensions, application criteria, material criteria, etc.) from an operator via a user interface and providing one or more calculations (e.g., stockpile volume, etc.) or recommendations (e.g., operating criteria, equipment settings, etc.) at least partially based on the collected data. The cloud-connected services 150 optionally include a parts data server 159a (e.g., operable to receive, store or supply availability, price, lead time, and/or dimensions or other characteristics of various parts such as those incorporated in the stationary or mobile equipment). The parts data server 159a optionally includes information about the operational life of parts which may be a constant value or a set of values correlated to one or more operating criteria or environmental conditions; in some embodiments, this operational life information is based on data gathered for parts, equipment or plants within and/or outside of the system 100. The cloud-connected services 150 optionally include a parts ordering interface 159b operable to enable, schedule, send, accept, and/or process an order for one or more parts. The cloud-connected services 150 optionally include maintenance information 159c on a server or database operable to store or provide maintenance logs, schedules, notes, etc. and other information relevant to the stationary or mobile equipment. The cloud-connected services 150 optionally include a personnel database 159d (e.g., operable to provide and/or receive information such as names, experience levels, training progress, incident reports, efficiency, wages, etc. associated with personnel performing operations or maintenance on the equipment).

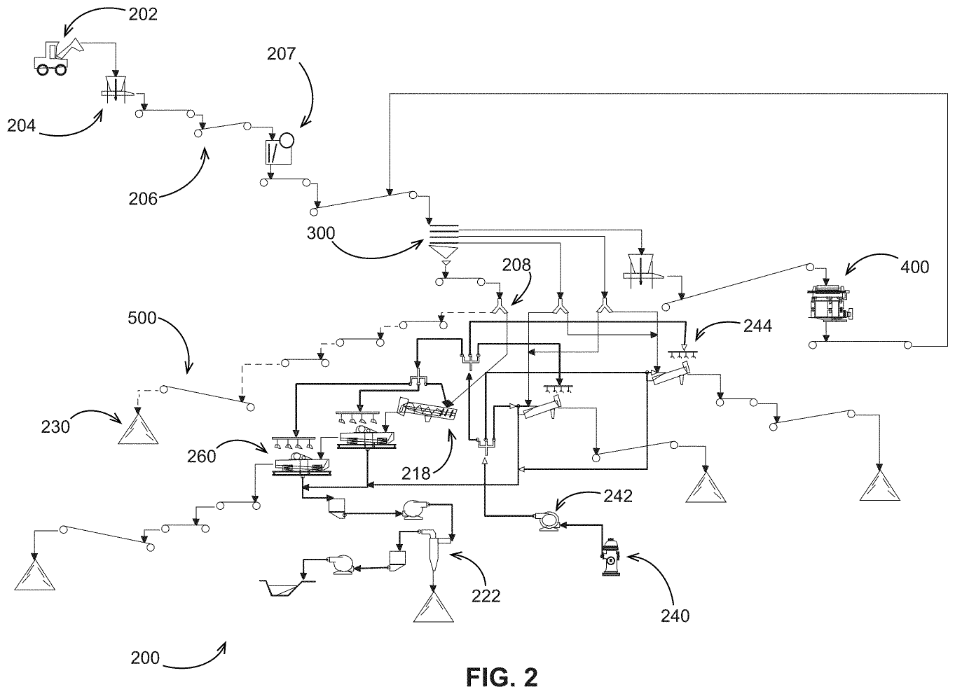

Referring to FIG. 2, an exemplary stationary aggregate processing plant 200 is illustrated schematically. The plant 200 is optionally associated with one or more stationary equipment control & monitoring systems 110 and/or one or more product sensor arrays 170, one or more of which (e.g., one or more sensors or actuators thereof) may be associated with any one or more of the items of equipment of the plant 200 (or components thereof) described in the following paragraph.

Continuing to refer to FIG. 2, in some embodiments the plant 200 is provided with unprocessed aggregate material by a loader 202 or other vehicle or apparatus. The material is optionally initially classified by a classifier 204 (e.g., vibratory feeder such as a grizzly feeder).

The material is optionally transferred by one or more conveyors 206 (e.g., stationary “jump” conveyors, etc.) between components of the plant 200. Some plant embodiments include one or more crushers (e.g., jaw crusher 207, cone crusher 400, vertical shaft impact crusher, horizontal shaft impact crusher, etc.) for crushing material. Some embodiments of the plant 200 include a vibratory screen 300 (e.g., inclined screen or horizontal screen) for classifying aggregate material. Some embodiments of the plant 200 include optionally actuatable flow redirection apparatus 208 (e.g., chutes, flumes, knife gates, butterfly valves, etc.) for redirecting (e.g., selectively redirecting, partially redirecting, completely redirecting, etc.) material (e.g., dry or wet material) to various components of the plant 200. Some embodiments of the plant 200 include one or more sand screws 218 for processing (e.g., cleaning, dewatering, etc.) aggregate material. Some embodiments of the plant 200 include one or more stacking conveyors 500 (e.g., telescopic conveyors, radial stacking conveyors, etc.) for storing aggregate material in a stockpile 230 (e.g., conical stockpile, kidney shaped stockpile, etc.) Some embodiments of the plant 200 include one or more dewatering screens 260 for removing water from and/or cleaning aggregate material. Various items of equipment (e.g., vibratory screens, sand screws, dewatering screens) of the plant 200 optionally include one or more fluid injection apparatus 244 (e.g., spray bars, spray valves, etc.) for adding (e.g., spraying, injecting, etc.) water or other fluid to the item of equipment and/or to material being processed or moved thereby. In some embodiments, a water source 240 is used to provide water to one or more items of equipment or components of the plant 200, e.g. by one or more pumps 242. The plant 200 optionally includes one or more hydrocyclones 222 or other wet classifying equipment for classifying aggregate material.

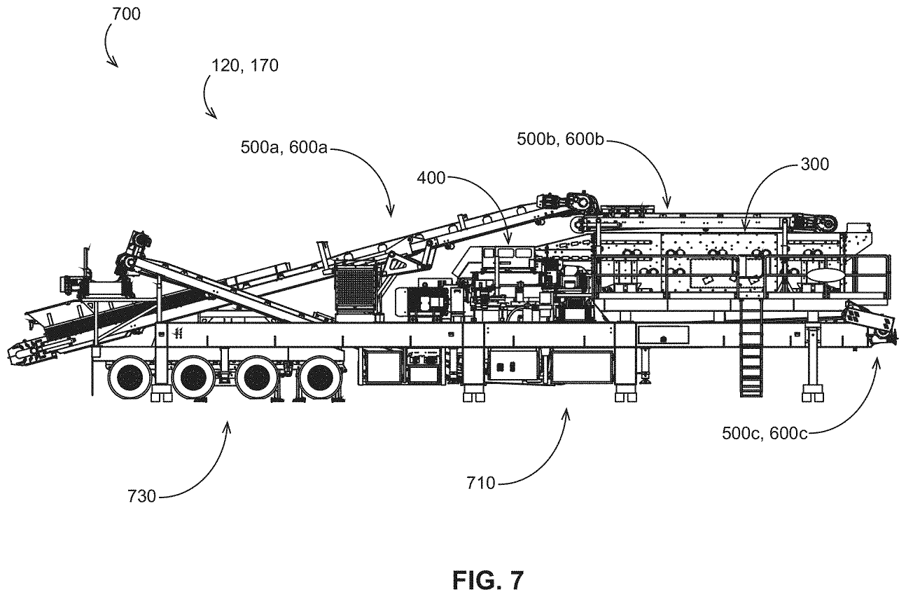

Referring to FIG. 7, an exemplary embodiment of a mobile or portable aggregate processing plant 700 is illustrated. The plant 700 is optionally associated with one or more mobile equipment control & monitoring systems 120 and/or one or more product sensor arrays 170, one or more of which (e.g., one or more sensors or actuators thereof) may be associated with any one or more of the items of equipment of the plant 700 (or components thereof) described in the following paragraph. In some embodiments, the mobile plant 700 is optionally moved (e.g., towed or driven) to a stationary plant and used to process aggregate material as part of the stationary plant process.

Continuing to refer to FIG. 7, in some embodiments the plant 700 optionally comprises a one or more input conveyors 500. The plant 700 optionally comprises a vibratory screen 300 (e.g., horizontal screen, etc.). In some embodiments the plant 700 optionally comprises a crusher 400 (e.g., cone crusher, etc.) which is optionally disposed to receive at least a portion of material passing over screen 300. In some embodiments one or more conveyors 500b move material internally between components of the plant 700. In some embodiments the plant 700 optionally comprises one or more output conveyors 500c for conveying material from the plant 700 to another item of equipment and/or stockpile or other storage location. The conveyors and processing equipment of plant 700 are optionally supported on a chassis 710 which is optionally mobile (e.g., pit-portable or road-portable) on one or more mobility assemblies 730 such as wheels or tracks.

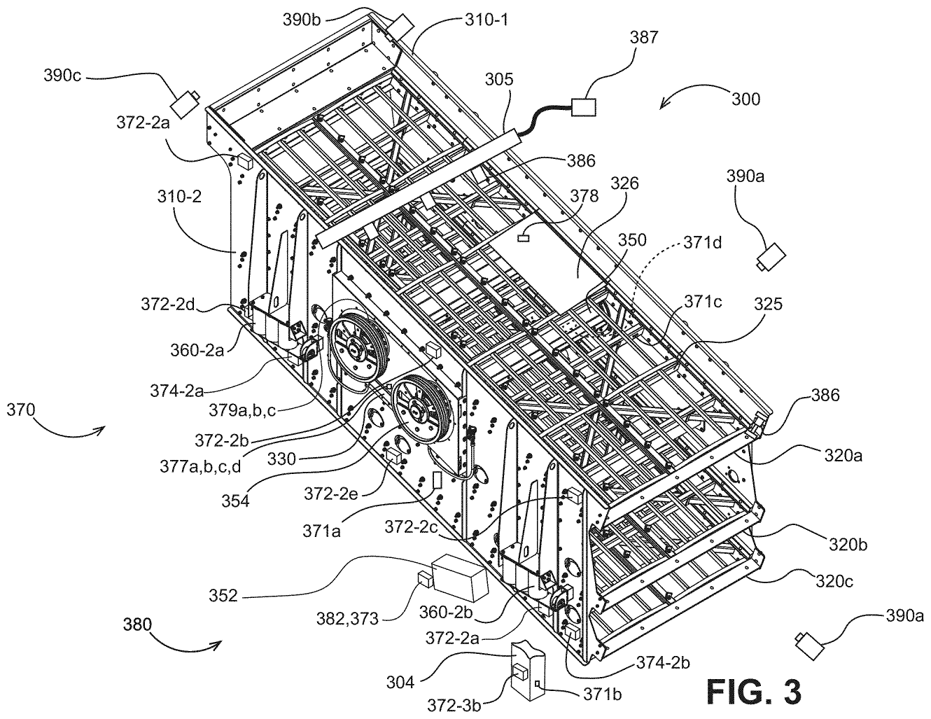

Continuing to refer to FIG. 3, the equipment control and monitoring system 120 and/or the product sensor array 170 optionally comprise one or more conveyor control and monitoring systems 600 associated with each conveyor 500. The equipment control and monitoring system 120 and/or the product sensor array 170 optionally comprise a control and monitoring system of the crusher 400. The equipment control and monitoring system 120 and/or the product sensor array 170 optionally comprise a control and monitoring system of the screen 300.

Referring to FIG. 3, a vibratory classifier 300 is illustrated having an array of equipment criteria sensors 370, an array of control elements 380, and one or more material sensors 390 which are optionally supported on or separate from the vibratory screen according to various embodiments.

The vibratory classifier 300 may comprise an incline screen, horizontal screen, feeder, dewatering screen, etc. The vibratory classifier 300 may have one or more decks of classifying media comprising cloth screens, metal screens, panels such as flat panels made of urethane or other material, grizzly bars, tines, etc.

In some embodiments, the vibratory classifier 300 comprises spaced sidewalls 310 (e.g., 310-1, 310-2) joined by a plurality of cross members 325. One or more classifying decks 320 (e.g., 320a, 320b, 320c) optionally extend between the sidewalls. Each deck 320 optionally supports one or more classifying media 326 (e.g., cloth screens, metal screens, panels such as flat panels made of urethane or other material, etc.) through which undersize material falls during vibratory operation of the classifier 300 and over which oversize material passes to a discharge end of the classifier 300.

The classifier 300 is optionally supported on (and/or in some embodiments supports) one or more bearing shafts 350 optionally having eccentric weights for driving rotation of the classifier. One or more bearing shafts 350 optionally includes a flywheel 354 or other input for rotating the shafts. The flywheel 354 or other input is optionally driven by a drive 352 such as an electric motor. The flywheels 354 and/or the bearing shafts 350 are optionally in fluid communication with an oil housing 330.

The classifier 300 is optionally resiliently supported on a plurality of springs 360 or other resilient elements.

One or more fluid injection elements 305 are optionally disposed to inject (e.g., spray, etc.) water or other fluid onto the classifier 300 (e.g., onto an upper deck or other deck thereof).

The equipment criteria sensor array 370 optionally includes one or more kinetic sensors 372 (e.g., accelerometers, three-axis accelerometers, gyroscopes, vibration sensors, etc.) optionally disposed at a plurality of locations on each sidewall 310 and optionally configured to record kinetic data (e.g., acceleration, frequency, velocity, position) and/or an oscillatory path of the classifier 300 during operation. One or more pairs of kinetic sensors 372 are optionally disposed at corresponding locations (e.g., along a common laterally and/or horizontally extending axis) of the sidewalls 310-1, 310-2 such that kinetic data and/or the oscillating paths of corresponding locations on the sidewalls can be compared. One or more kinetic sensors 372 is optionally disposed on one or more structural support members 304. One or more energy consumption sensors 373 are optionally configured to detect an operating criterion related to energy consumption such as the energy consumption by the drive 352 (e.g., current draw, power draw, voltage, etc.)

The equipment criteria sensor array 370 optionally includes one or more load cells 374 disposed to at least partially support a weight of the classifier 300. The equipment criteria sensor array 370 optionally includes one or more strain gauges 371 for measuring a strain on the classifier 300 (e.g., strain gauge 371a disposed on one or more sidewalls 310, strain gauge 371b disposed on one or more structural support members 304, strain gauge 371c disposed on one or more cross members 325, and/or strain gauge 371d disposed on one or more bearing shafts 350).

The equipment criteria sensor array 370 optionally includes one or more wear sensors 378 (e.g., inductive sensors, motion sensors, optical sensors, electromagnetic sensors, etc.). In some embodiments, one or more wear sensors 378 are disposed on or adjacent to one or more classifying media 326 in order to measure a wear level of the media.

The equipment criteria sensor array 370 optionally includes one or more oil characteristic sensors 377 which in some embodiments are disposed in the oil housing 330 and/or are in fluid communication with the oil housing or oil supplied to the oil housing 330 or the bearing shafts 350. The oil characteristic sensors optionally include an oil temperature sensor 377a, an oil level sensor 377b (e.g., ultrasonic or optical sensor), an oil particle monitor 377c, and/or an oil moisture sensor 377d.

The equipment criteria sensor array 370 optionally includes one or more bearing operational characteristic sensors 379 optionally disposed to measure an operational characteristic of one or more bearings supporting one or more bearing shafts 350. The bearing operational characteristic sensors 379 optionally include vibration sensors 379a, temperature sensors 379b, and/or bearing wear sensors 379c. In some embodiments, the bearing operational characteristic sensors 379 comprise an Enlight Collect IMx-1 bearing monitor system available from SKF.

One or more material sensors 390 optionally comprise one or more of sensors (e.g., camera, optical sensor, height sensor, temperature sensor, distance sensor, UV sensor, ultrasonic transmitter/receiver, etc.) which may be configured to evaluate (e.g., the determine amount, height, weight, density, segregation, moisture, water content, particle size distribution, temperature, color, or other characteristic) of material passing onto, over, through or out of the classifier 300 (e.g., over an upper deck, lower deck, middle deck, or other deck thereof). The material sensor 390 may be disposed remotely from the classifier 300 and/or on the classifier 300 (e.g., on a sidewall thereof and oriented toward aggregate material on a deck 320). A plurality of sensors 390 may be configured to sense and/or characterize material on various locations on or adjacent to the classifier 300 (e.g., before being deposited thereon, while on an upper deck thereof, while on a lower deck thereof, after falling through one or more decks thereof, at an entrance end thereof, at a discharge end thereof, after being deposited off of a discharge end thereof, etc.)

The control element array 380 optionally comprises one or more application controllers 387 (e.g., flow control valves, shut-off valves, variable rate pumps, etc.) for modifying a rate of fluid application (e.g., water application) via one or more fluid injector elements 305. In some embodiments a plurality of individually controlled controllers 386 (e.g., injection valves, spray valves, etc.) are arrayed across a length of a fluid injector element 305 and optionally oriented to deposit water onto the classifier 300.

The control element array 380 optionally includes one or more actuators for modifying the angle of one or more decks 320 and/or of the entire classifier 300.

The control element array 380 optionally includes one or more drive controllers 382 for modifying a speed, frequency or other operational characteristic of the drive 352 and/or for selectively turning the drive 352 on or off.

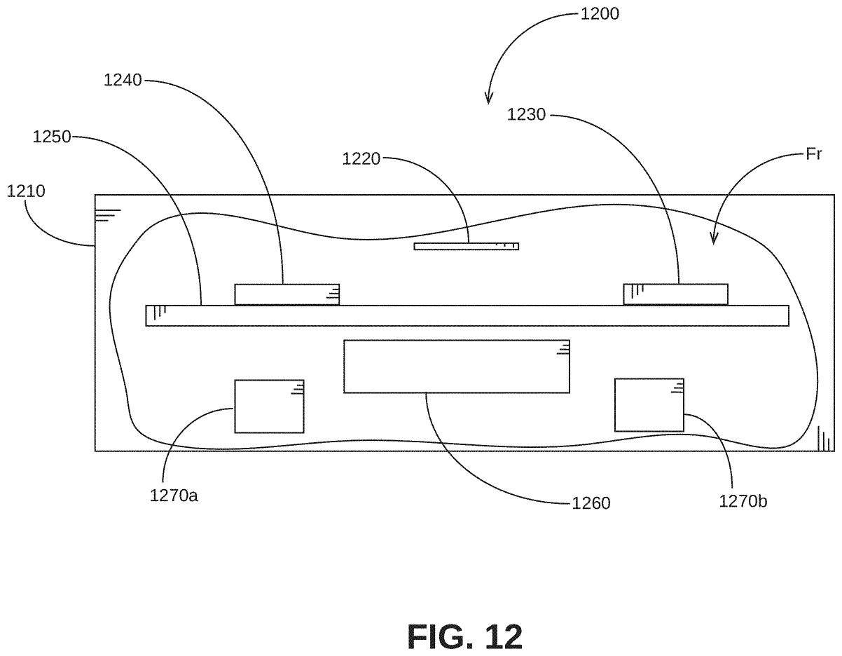

Referring to FIG. 12, an example embodiment of a kinetic sensor 372 is illustrated as a sensor module 1200. In some embodiments the sensor module 1200 includes a housing 1210 (e.g., plastic housing) which optionally at least partially encloses the operative components of the sensor module. The housing 1210 may be of any shape (e.g., rectangular, oval, circular, etc.). In some embodiments the housing 1210 is at least partially filled with a resin fill Fr or other fill in which the components of the sensor module are supported (e.g., at least partially suspended). The sensor module 1200 optionally includes one or more magnets 1270 (e.g., 1270a, 1270b) for removably attaching the sensor module to sidewalls or other structure. It should be appreciated that the sensor module 1200 can thus be removably attached to a selected location on the vibratory screen without the use of fasteners or tools. The sensor module 1200 optionally includes one or more batteries 1260 (or in some embodiments energy storage devices such as one or more capacitors etc.) in electrical communication with a circuit board 1250. In some embodiments, the battery 1260 is replaced or charged by an vibration-powered generator (e.g., piezoelectric generator, electromagnetic generator, etc.). The circuit board 1250 optionally includes an accelerometer 1230 (e.g., 3-axis accelerometer) configured to generate one or more signals related to the acceleration of the sensor module 1200. The circuit board 1250 optionally includes a processor 1240 for processing the signals from the accelerometer 1230 in order to generate processed acceleration data. The circuit board 1250 is optionally in data communication (e.g., electrical, electronic, wireless or radio communication) with an antenna 1220 for transmitting information (e.g., processed acceleration data and/or signals) to a receiver remote from the sensor module. In other embodiments, a different device or system may be used to transmit information to a receiver remote from the sensor module.

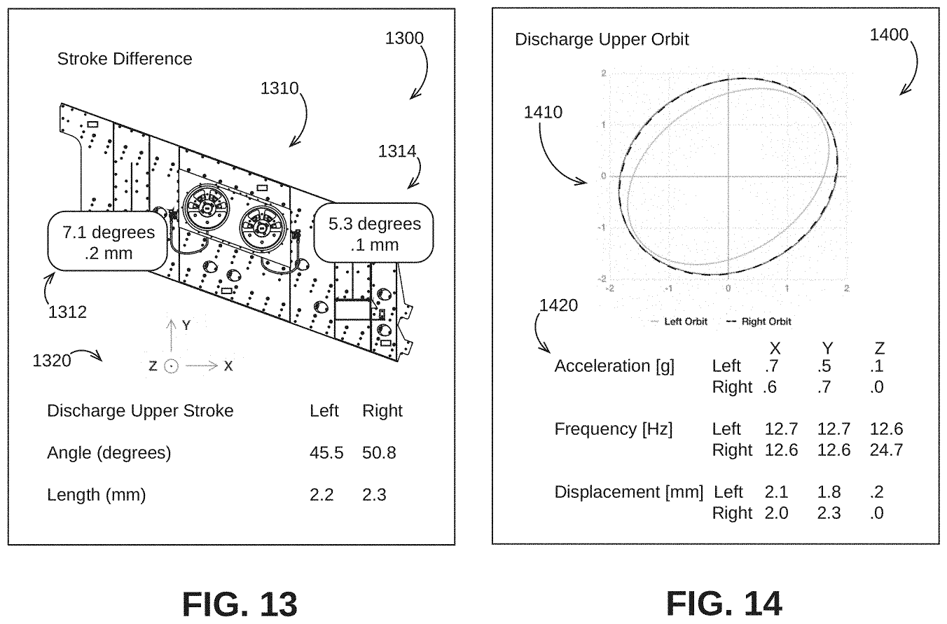

Referring to FIG. 13, a user interface 1300 (e.g., display screen, browser page, mobile application display, etc.) optionally displays a representation 1310 of the vibratory screen with data values (e.g., differences in stroke angle and stroke length between opposing sidewalls at various locations) superimposed on associated locations 1312, 1314 on the vibratory screen. In some embodiments, a table 1320 displays data (e.g., differences in stroke angle and length) for various locations on the vibratory screen. Referring to FIG. 14, another user interface 1400 optionally displays an orbit graph 1410 displaying and superimposing oscillatory orbits of associated locations on the left sidewall and right sidewall. In some embodiments, a table 1420 displays further data (e.g., acceleration, frequency, displacement, etc.) measured at associated locations on the left sidewall and right sidewall (e.g., along the X, Y and Z directions illustrated in FIG. 14).

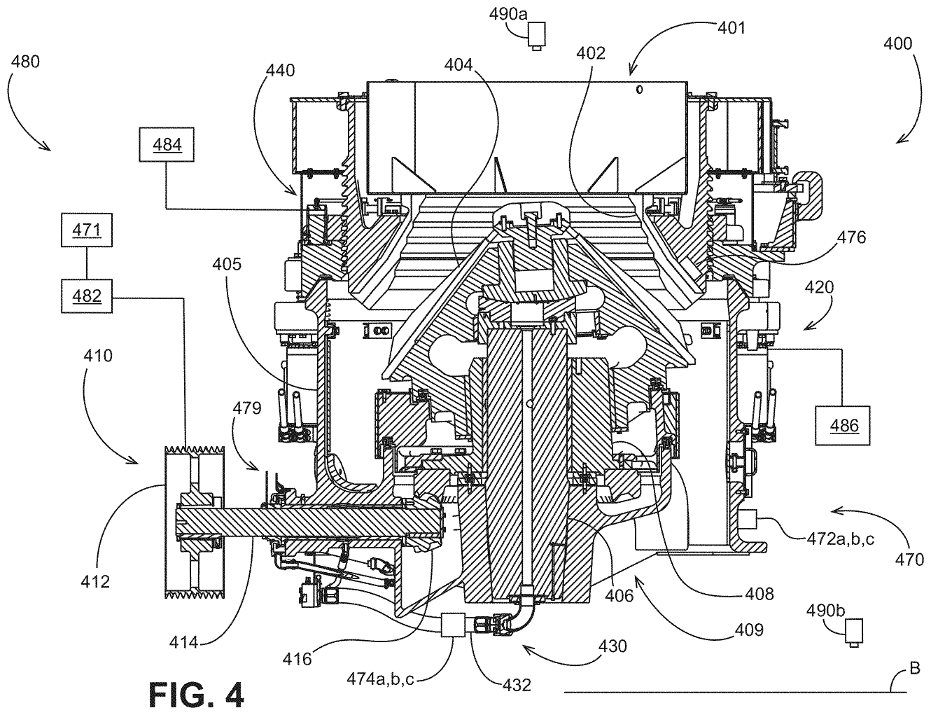

Referring to FIG. 4, a crusher 400 is illustrated having an array of equipment criteria sensors 470, an array of control elements 480, and one or more material sensors 490 which are optionally supported on or separate from the vibratory screen according to various embodiments. Although the crusher 400 is illustrated as a cone crusher, in various embodiments one or more of the equipment criteria sensors, control elements, or material sensors described herein may be incorporated in other crushing equipment including jaw crushers, impactors (e.g., vertical shaft or horizontal shaft impactors), gyratory crushers, etc.

Continuing to refer to FIG. 4, the crusher 400 optionally comprises a feed inlet area 401 from which aggregate material passes between a bowl 402 and head 404 for crushing therebetween. In some embodiments the head 404 gyrates at least partially within the bowl 402 due to rotation of a shaft 406 (e.g., a shaft surrounded by an eccentric portion 408) rotatably supported in a housing 405. Housing 405 optionally includes a discharge opening 409 for discharging at least partially crushed material, e.g., onto a belt B. In some embodiments, the shaft 406 is driven by a drive assembly 410 optionally comprising a flywheel 412 and countershaft 414 with an output gear 416 configured to drive shaft 406. A lubrication system 430 optionally comprises one or more lubricant conduits 432 configured to supply lubricant (e.g., oil, etc.) to one or more components of the crusher (e.g., head shaft, head, etc.). A crushing gap adjustment system 440 is optionally provided for adjusting a crushing gap (e.g., distance between head and bowl, close side setting, etc.) such as by rotating the bowl within vertical adjustment threads by a motor or other mechanism. A tramp relief system 420 (e.g., one or more hydraulic cylinders) is optionally provided for temporarily lifting the bowl in the case of a tramp event (e.g., uncrushable material between head and bowl, seizing of the head, etc.).

The equipment criteria sensor array 470 optionally includes one or more kinetic sensors 472a (e.g., accelerometers, three-axis accelerometers, gyroscopes, vibration sensors, etc.) optionally disposed at one or more locations (e.g., on the head shaft, head, bowl, housing, countershaft, flywheel, etc.) and optionally configured to record kinetic data (e.g., acceleration, frequency, velocity, position) during operation. One or more energy consumption sensors 471 are optionally configured to detect an operating criterion related to energy consumption such as the energy consumption by a drive 482 (e.g., current draw, power draw, voltage, etc.)

The equipment criteria sensor array 470 optionally includes one or more strain gauges 472b for measuring a strain on one or more components of the crusher 400 (e.g., a strain gauge 472b disposed on the head shaft, head, bowl, housing, countershaft, flywheel, etc.).

The equipment criteria sensor array 470 optionally includes one or more strain gauges 472c for measuring a temperature of one or more components of the crusher 400 (e.g., a strain gauge 472c disposed on the head shaft, head, bowl, housing, countershaft, flywheel, etc.).

The equipment criteria sensor array 470 optionally includes one or more wear sensors 476 (e.g., inductive sensors, motion sensors, optical sensors, electromagnetic sensors, etc.). In some embodiments, one or more wear sensors 378 are disposed on or adjacent to one or more consumable liners (e.g., bowl liners, etc.) or other wear components in order to measure a wear level of the liners.

The equipment criteria sensor array 470 optionally includes one or more lubricant characteristic sensors 474 (e.g., flow sensors 474a, viscosity sensors 474b, temperature sensors 474c, etc.) in fluid communication with the lubrication system 430 (e.g., one or more conduits thereof).

The equipment criteria sensor array 470 optionally includes one or more operational characteristic sensors 479 optionally disposed to measure an operational characteristic of one or more bushings or bearings supporting one or more shafts of the crusher. The operational characteristic sensors 479 optionally include vibration sensors, temperature sensors, and/or bearing wear sensors.

One or more material sensors 490 optionally comprise one or more of sensors (e.g., camera, optical sensor, height sensor, temperature sensor, distance sensor, UV sensor, ultrasonic transmitter/receiver, etc.) which may be configured to evaluate (e.g., the determine amount, height, weight, density, segregation, moisture, water content, particle size distribution, temperature, color, or other characteristic) of material passing onto, over, through or out of the crusher 400 (e.g., over an upper deck, lower deck, middle deck, or other deck thereof). The material sensor 490 may be disposed remotely from the crusher 400 and/or on the crusher 400. A plurality of sensors 490 may be configured to sense and/or characterize material on various locations on or adjacent to the classifier 300 (e.g., a sensor 490a may sense material in the feed inlet and/or a sensor 490b may sense material discharged onto belt B or other location, etc.)

The control element array 480 optionally includes one or more drive controllers 482 configured to modify a speed, frequency or other operational characteristic of the crusher and/or configured to selectively turn the crusher on or off.

The control element array 480 optionally includes one or more tramp relief controllers 486 for selectively actuating the tramp relief system 420 (e.g., selectively extending one or more tramp relief cylinders, etc.).

The control element array 480 optionally includes one or more crushing gap controllers 484 for selectively actuating the crushing gap adjustment system 440 (e.g., selectively turning one or more input gears to turn the bowl within vertical adjustment threads, etc.).

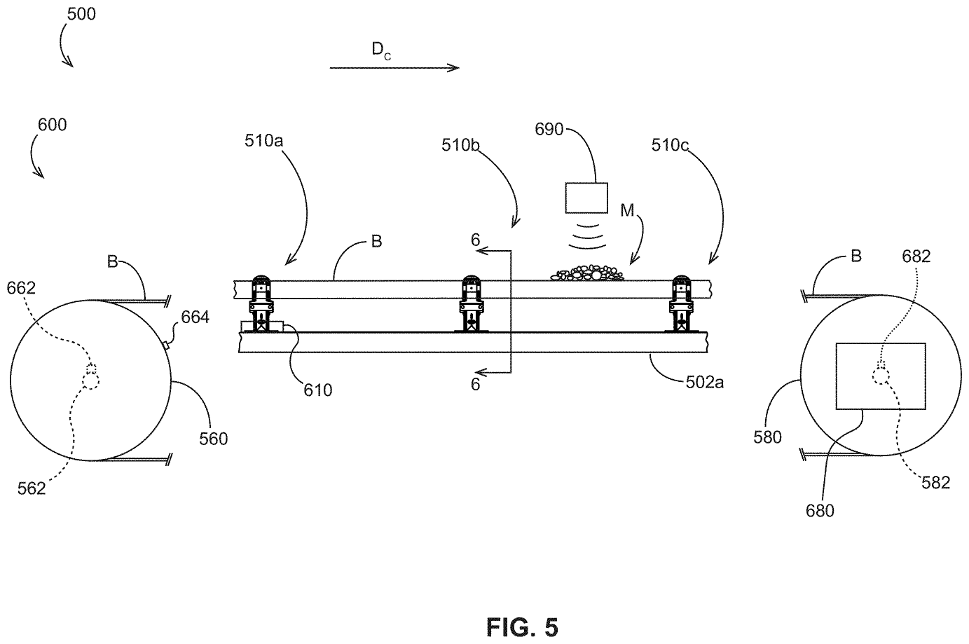

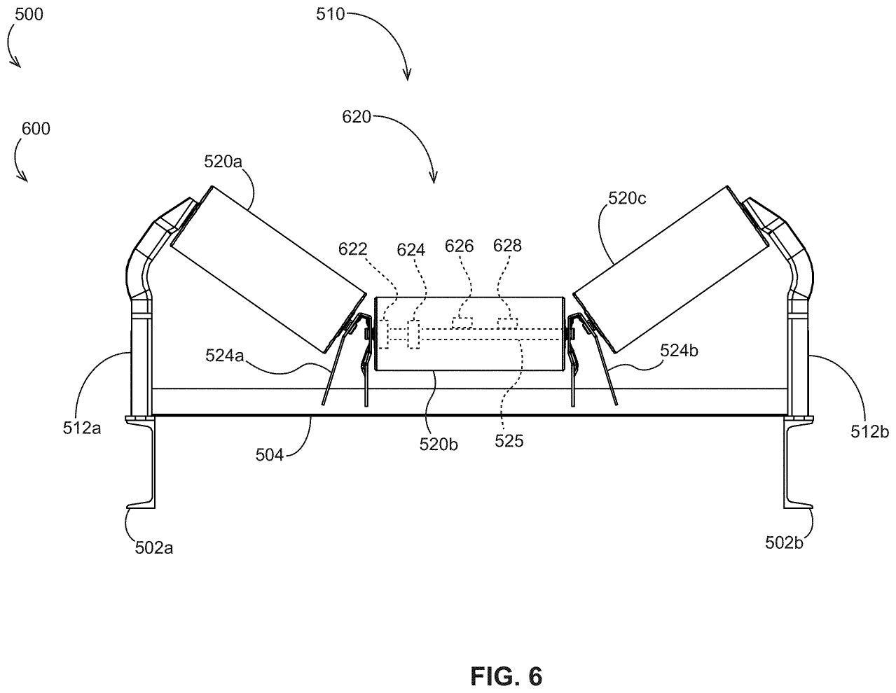

Referring to FIGS. 5 and 6, an embodiment of a conveyor 500 incorporating a conveyor control and monitoring system 600.

The conveyor 500 optionally includes an endless belt B operably supported on a head pulley 580, a plurality of idler assemblies 510, and a tail pulley 560. Material M is conveyed on belt B along a direction of conveyance Dc. Head pulley 580 is optionally a driven pulley. Head pulley 580 is optionally supported on a shaft 582. Tail pulley 560 is optionally supported on a shaft 562. Each idler assembly 510 is optionally supported on a pair of longitudinally extending rails 502a, 502b.

One or more idler assemblies 510 optionally comprise troughing idler assemblies as illustrated in FIG. 6, e.g. having a generally horizontal center idler 520b and angled wing idlers 520a, 520c. Each wing idler 520a, 520c is optionally rollingly supported on an outer riser 512 and an inner perch support 524. The center idler 520b is optionally rollingly supported on perch supports 524a, 524b. The risers 512 and perch supports 524 are optionally supported on a cross member 504. Each idler 520 is optionally supported on a shaft 525.

The conveyor control and monitoring system 600 optionally comprises a plurality of sensors associated with one or more idlers 520 (e.g., wing idlers, center idlers, etc.). In some embodiments, the sensors include one or more bearing temperature sensors 622 configured to measure a temperature of a bearing supporting the idler, one or more rotation sensors 624 configured to measure a rotation and/or rotational speed of the idler, a load sensor 626 (e.g., load cell or strain gauge) optionally mounted to shaft 525 and configured to measure a load on the shaft 525, and an internal temperature sensor 628 configured to measure a temperature of an internal surface and/or volume of the idler.

The system 600 optionally comprises a load sensor 662 configured and disposed to measure a load on the shaft 562. The system 600 optionally comprises a load sensor 682 configured and disposed to measure a load on the shaft 582. The system 600 optionally includes one or more embedded sensors 664 (e.g., load cells, temperature sensors, etc.) embedded in pulley lagging on one or more of the pulleys 560, 580.

The system 600 optionally comprises a product sensor array. The product sensor array of system 600 optionally comprises a material sensor 690 disposed and configured to detect one or more material characteristics (e.g., an amount, presence, type, density, height, width, pile shape, and/or pile segregation of material M on at least a portion of belt B). The product sensor array of system 600 optionally comprises a scale 610 (e.g., belt scale) which is optionally disposed to at least partially support a weight of an idler assembly 510 and/or optionally configured measure a weight of material M on at least a portion of belt B.

The system 600 optionally comprises a control element array having one or more controllers for modifying an operating criterion of the conveyor 500. The controllers optionally include a motor 680 (e.g., electric motor, internal motor, external motor, etc.) having variable speed and operably coupled the pulley 580 for driving the pulley 580.

The system 600 (e.g., one or more sensors and/or control elements thereof) are optionally a component of and/or are in data communication with the system 100 such that the sensors and/or controllers of system 600 are in data communication with the computing devices and/or network of system 100.

A conveyor 500 having a conveyor control and monitoring system 600 may be disposed to convey input material into one or more items of equipment (e.g., crusher, screen, etc. such as those described herein), optionally from another item of equipment. A conveyor 500 having a conveyor control and monitoring system 600 may be disposed to convey output material into one or more items of equipment (e.g., crusher, screen, etc. such as those described herein), optionally to another item of equipment or to a stockpile or other storage location.

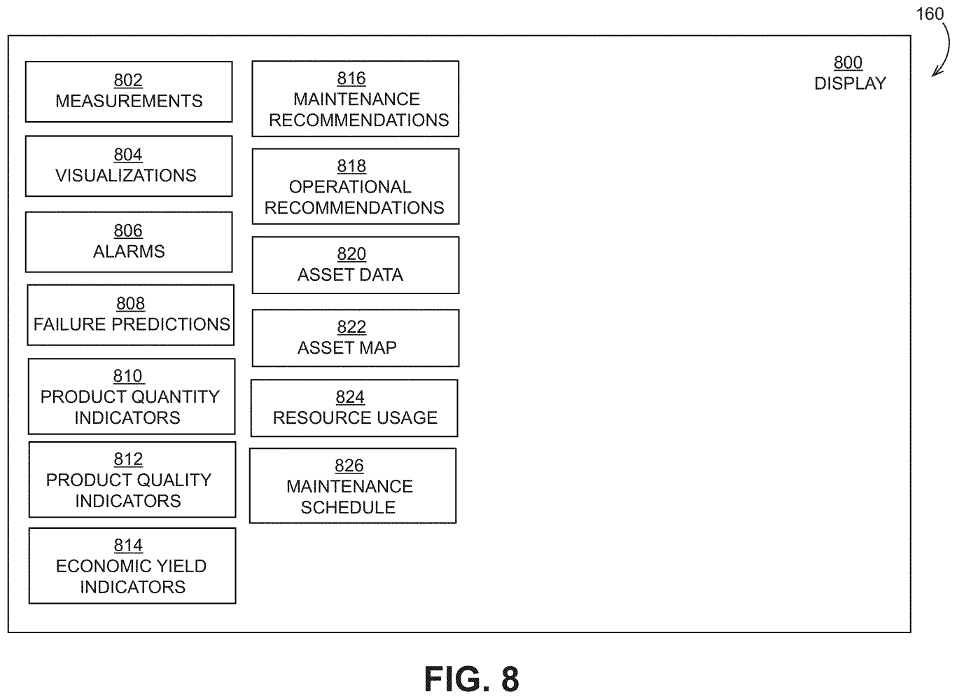

Referring to FIG. 8, an exemplary graphical user interface display 800 is illustrated. The display 800 is optionally in data communication with one or more elements of the system 100 for displaying information from and/or gathering user input for the system 100. The display 800 optionally displays one or more of the following: measurements 802 (e.g., equipment measurements, product measurements, etc.); visualizations 804 (e.g., of one or more measurements 802 visualized over time and/or visualized against one or more other measurements); alarms 806 (e.g., indicating that one or more measurements have exceeded an associated amount threshold and/or trend threshold); failure predictions 808 (e.g., indicating that one or more parts or items of equipment are predicted to fail within a time and/or operating time); product quantity indicators 810 (e.g., indicating an amount by weight, volume, tons per hour, etc. of product produced by an item of equipment and/or overall plant); product quality indicators 812 (e.g., indicating a moisture, temperature, gradation, material specification satisfaction, material content, etc. of product produced by an item of equipment and/or overall plant); economic yield indicators 814 (e.g., indicating a net economic yield, product revenue, etc. from operation of the plant over time and/or per unit of time); maintenance recommendations 816 (e.g., indicating an alarm or scheduled or recommended time to repair or replace one or more parts); operational recommendations 818 (e.g., indicating a recommended change in one or more operating criteria); asset data 820 (e.g., one or more locations, hours of operation, fuel consumption, fuel efficiency, maintenance logs, production efficiency, etc. of an item of equipment and/or plant); an asset map 822 (e.g., indicating one or more locations of multiple items of equipment and/or plants); resource usage 824 (e.g., indicating an amount of energy, electricity, power, fuel, etc. used by one or more items of equipment and/or plants); and/or a maintenance schedule 826 (e.g., recommended times of one or more maintenance actions recommended by the system 100 and/or scheduled by an operator).

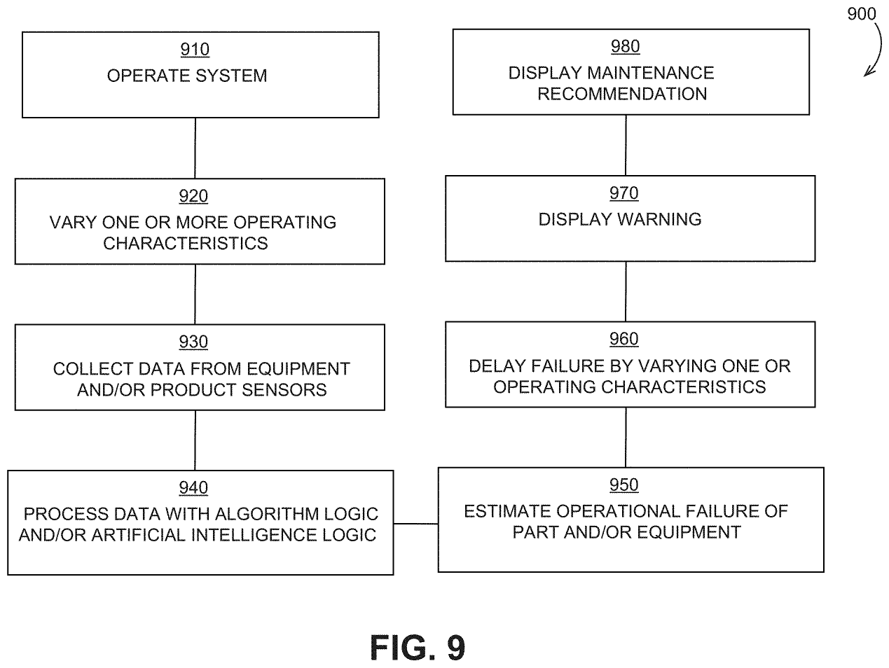

Referring to FIG. 9, a method 900 of operating one or more embodiments of system 100 is illustrated. At step 910 the system 100 is operated (e.g., by commanding one or more drives to operate individual items of equipment). At step 920, the system 100 optionally varies one or more operating characteristics (e.g., as instructed by the operator, as determined by the system 100 for operational purposes, and/or in order to generate system response data, such as by operating at a plurality of speeds, frequencies, angles, strokes, close-side settings, etc. within ranges for productive operation of the system). At step 930, the system 100 optionally collects data from the equipment and/or product sensors during operation of the system (e.g., at each varied operating characteristic of step 920). At step 940, the system 100 optionally processes data with the algorithm logic and/or artificial intelligence logic. At step 950, the system 100 optionally estimates (e.g., using the algorithm logic and/or artificial intelligence logic) an operational failure of a part and/or article of equipment (e.g., a time to failure, an operational time to failure, an operating characteristic that will cause failure, etc.) At step 960, the system 100 optionally delays the estimated failure by varying (e.g., by an amount determined using the algorithm logic and/or artificial intelligence logic) one or more operating characteristics (e.g., reducing a speed or frequency and/or varying a stroke, a close-side setting, etc.). In some embodiments the system 100 delays the estimated failure by stopping one or more articles of equipment from operating. At step 970, the system 100 optionally displays a warning related to the estimated failure. At step 980, the system 100 optionally displays a maintenance action recommendation (e.g., including one or more of an item of equipment predicted to fail, an identification such as a part number of a part predicted to fail, a recommended time of replacement, a recommended operational time to replacement, part ordering details, part prices, part replacement or repair times and/or costs, an estimated additional cost of foregoing the maintenance recommendation, etc.). The maintenance action recommendation is optionally determined using the algorithm logic and/or artificial intelligence logic.

In some embodiments of the methods described herein (e.g., method 900), a bushing failure (e.g., jaw crusher bushing, cone crusher bushing, conveyor idler bushing, etc.) is predicted. In some embodiments, the bushing failure is predicted based on bushing temperature and/or bushing temperature trend. In some embodiments, the bushing failure is predicted based on “coast-down time” of the bushing (e.g., the time required to reach 0 rpm after the equipment is no longer powered) and/or or a coast-down time trend. In some embodiments, an oil temperature differential (or trend thereof) between oil temperature entering and exiting the bushing is used to predict the bushing failure.

In some embodiments of the methods described herein (e.g., method 900), the presence of certain weather conditions (e.g., precipitation, likely precipitation, etc.) triggers an alarm for certain equipment.

In some embodiments of the methods described herein (e.g., method 900), altitude and/or ambient temperature may be consulted to adjust the maximum power draw permitted by one or more items of equipment before a shutdown or alarm condition is imposed.

In some embodiments of the methods described herein (e.g., method 900), the vibration of a chassis or structure is measured and compared to thresholds (e.g., thresholds reflected in a safety manual, warranty document, etc. to determine whether a shutdown or alarm condition has been reached.

In some embodiments of the methods described herein (e.g., method 900), one or more images of screen media (e.g., having color-coded wear layers) is consulted in order to predict a failure or unacceptable wear condition of the screen media.

In some embodiments of the methods described herein (e.g., method 900), an overloading or uneven feed distribution is determined by comparing load cell or other weight information from two or more regions of a vibratory screen, and/or using one or more images of material on top of a vibratory screen deck.

In some embodiments of the methods described herein (e.g., method 900), an overloading or uneven feed distribution is determined by comparing load cell or other weight information from two or more regions of a vibratory screen, and/or using one or more images of material on top of a vibratory screen deck. The overloading or uneven feed distribution may be reported as an alarm and/or quantified and reported as a score of distribution evenness or acceptable distribution loading percentage.

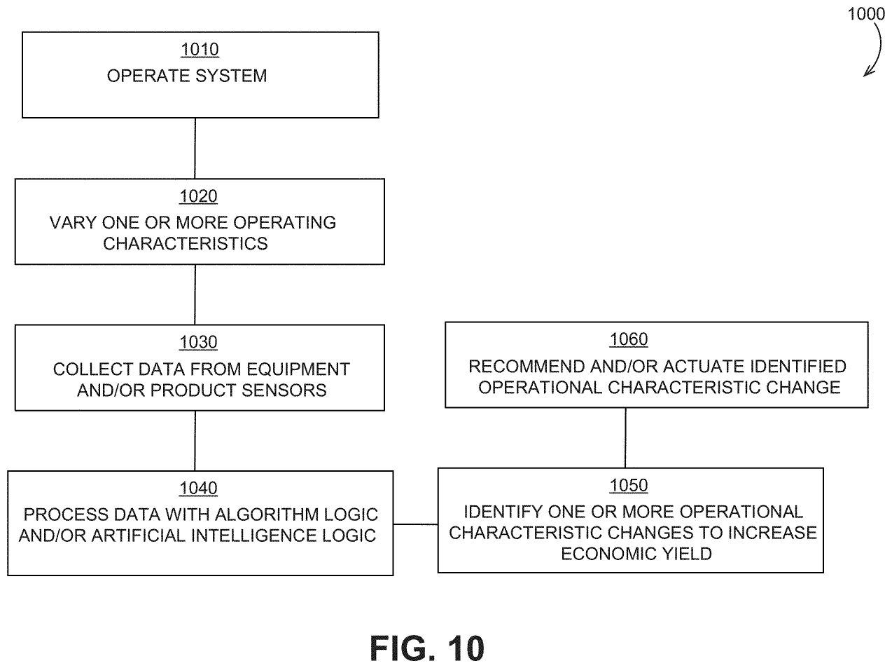

Referring to FIG. 10, a method 1000 of operating one or more embodiments of system 100 is illustrated. At step 1010 the system 100 is operated (e.g., by commanding one or more drives to operate individual items of equipment). At step 1020, the system 100 optionally varies one or more operating characteristics (e.g., as instructed by the operator, as determined by the system 100 for operational purposes, and/or in order to generate system response data, such as by operating at a plurality of speeds, frequencies, angles, strokes, close-side settings, etc. within ranges for productive operation of the system). At step 1030, the system 100 optionally collects data from the equipment and/or product sensors during operation of the system (e.g., at each varied operating characteristic of step 1020). At step 1040, the system 100 optionally processes data with the algorithm logic and/or artificial intelligence logic. At step 1050, the system 100 optionally identifies (e.g., using the algorithm logic and/or artificial intelligence logic) one or more operational characteristic changes in order to increase an economic yield (e.g., overall material production, overall monetary yield, product revenue, etc.) of the system 100. In some embodiments, step 1050 is optionally performed in part using product commodity prices, resource costs, etc. At step 1060, the system 100 optionally recommends (e.g., by displaying an alert to an operator) and/or carries out (e.g., by sending a control signal) the identified operational characteristic change of step 1050.

In some embodiments of the methods described herein (e.g., method 1000), one or more operating characteristics are actuated using variable frequency drives, actuators, etc.: crusher close-side setting, countershaft speed, and/or feed rate of a conveyor, feeder or other device feeding material to the crusher.

In some embodiments of the methods described herein (e.g., method 1000), a recoil rate of one or more springs resiliently supporting a vibratory screen are adjusted in order to improve the vibratory or load balance of the screen. In some such embodiments, a wedge or other apparatus abutting a spring may be advanced or retracted in order to modify the recoil rate. In other such embodiments, a pressure of an air spring may be adjusted by a valve or other apparatus in order to modify the recoil rate.

In some embodiments of the methods described herein (e.g., method 1000), a vibratory screen frequency is temporarily increased in order to clean material off of one or more decks of the vibratory screen. In some embodiments of the methods described herein (e.g., method 1000), a vibratory screen deck is cleaned by actuating a beater bar or other clean-off apparatus configured to remove material from the deck. In embodiments, a frequency increase or clean-off apparatus actuation is instigated by determining that a production rate of one or more products generated by the screen is below a threshold associated with the current feed rate and/or vibratory frequency of the screen.

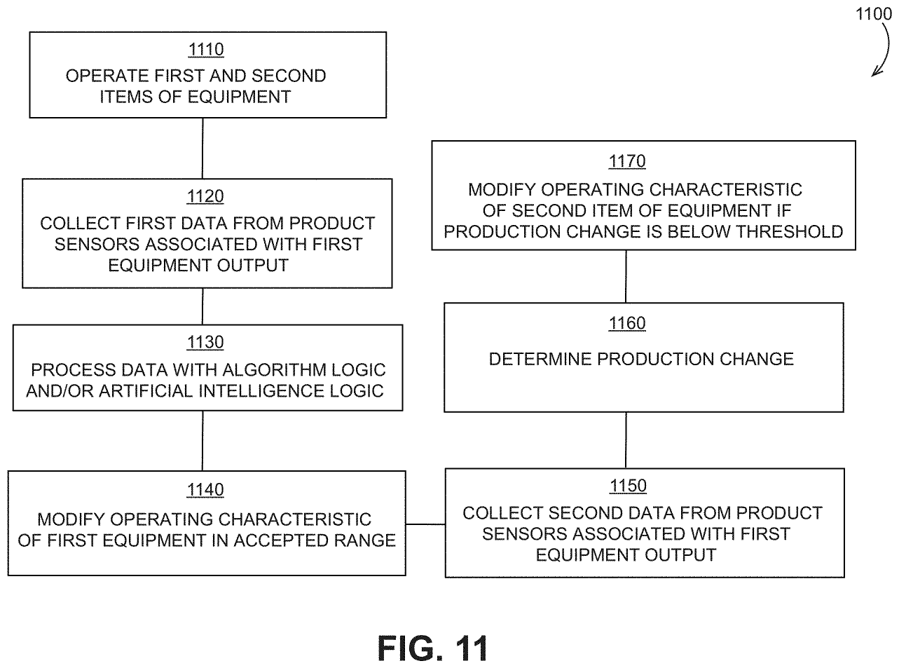

Referring to FIG. 11, a method 1100 of operating one or more embodiments of system 100 is illustrated. At step 1110, the system 100 optionally operates a plurality (e.g., first and second) items of equipment (e.g., two or more of a conveyor, crusher, vibratory screen, etc.) At step 1120, the system 100 optionally collects first data from product sensors associated with the output of a first item of equipment. At step 1120, the system 100 optionally processes the collected first data with algorithm logic and/or artificial intelligence logic. At step 1140, the system 100 optionally modifies one or more operating characteristics of the first item of equipment within an accepted range (e.g., within a accepted range of speed, frequency, stroke, close side setting, etc. which range may be stored in memory or entered by an operator). At step 1150, collect second data from the product sensors associated with the output of the first item of equipment. At step 1160, the system 100 optionally determines (e.g., using the algorithm logic and/or artificial intelligence logic) a production change (e.g., product amount, product amount per time, product amount per operating cycle, product quantity, etc.) associated with the first item of equipment. At step 1170, if the production change is below a desired threshold (e.g., percent change, absolute amount, etc. which threshold may be stored in memory or entered by an operator), the system 100 optionally modifies (e.g., by an amount determined using the algorithm logic and/or artificial intelligence logic) an operating characteristic of a second item of equipment (e.g., in order to increase the production change, etc.).

Although various embodiments have been described above, the details and features of the disclosed embodiments are not intended to be limiting, as many variations and modifications will be readily apparent to those of skill in the art. Accordingly, the scope of the present disclosure is intended to be interpreted broadly and to include all variations and modifications within the scope and spirit of the appended claims and their equivalents. For example, any feature described for one embodiment may be used in any other embodiment.

1. An aggregate processing system, comprising:
a computing device;
a plurality of equipment criteria sensors in data communication with said computing device, each of said plurality of equipment criteria sensors associated with one or more items of aggregate processing equipment;
a plurality of product sensors in data communication with said computing device, each of said plurality of product sensors configured to measure at least one of a quantity or characteristic of aggregate product processed by the aggregate processing system;
a plurality of control elements, each control element associated with one or more of said items of aggregate processing equipment, each control element configured to modify an operating characteristic of said associated aggregate processing equipment; and
a plurality of cloud-connected services for determining a recommended operating characteristic modification, each of said plurality of cloud-connected services including artificial intelligence logic.

2. The aggregate processing system of claim 1, wherein said artificial intelligence logic is configured to predict a failure of one of said one or more items of aggregate processing equipment.

3. The aggregate processing system of claim 1, wherein said artificial intelligence logic is configured to recommend a maintenance action to delay or prevent a failure of one of said items of equipment.

4. The aggregate processing system of claim 1, wherein said artificial intelligence logic is configured to recommend or actuate a change in one or more operating criteria of one or more of said items of aggregate processing equipment to increase an economic yield of the aggregate system.

5. The aggregate processing system of claim 1, wherein said plurality of equipment criteria sensors includes a kinetic sensor.

6. The aggregate processing system of claim 1, wherein said plurality of equipment criteria sensors includes a wear sensor.

7. The aggregate processing system of claim 1, wherein said plurality of equipment criteria sensors includes a load sensor.

8. The aggregate processing system of claim 1, wherein said plurality of equipment criteria sensors includes a temperature sensor.

9. The aggregate processing system of claim 1, wherein said plurality of product sensors includes a product quantity sensor.

10. The aggregate processing system of claim 1, wherein said plurality of product sensors includes a product characteristic sensor.

11. The aggregate processing system of claim 1, wherein at least one of said plurality of control elements is configured to modify an operational speed of at least one of said items of aggregate processing equipment.

12. The aggregate processing system of claim 1, wherein at least one of said plurality of control elements is configured to modify a gap size of at least one of said items of aggregate processing equipment.

13. The aggregate processing system of claim 1, wherein at least one of said plurality of control elements is configured to modify a range of motion of a component of at least one of said items of aggregate processing equipment.

14. A method of controlling and monitoring an aggregate processing system, comprising:
monitoring the aggregate processing system;
varying one or more operating characteristics of the aggregate processing system;
collecting first equipment criteria data from a first equipment criteria sensor associated with the aggregate processing system;
processing said collected first equipment criteria data with algorithm logic or artificial intelligence logic;
using the algorithm logic or artificial intelligence logic, estimating an operational failure of an item of equipment;
delaying said operational failure by varying one or more operating characteristics of said item of equipment;
displaying a warning related to said operational failure; and
recommending a maintenance action related to said estimated operational failure.

15. The method of claim 14, further comprising:
collecting product quantity data from one or more product quantity sensors associated with the aggregate processing system; and
processing said collected product quantity with algorithm logic or artificial intelligence logic.

16. The method of claim 14, further comprising:
collecting product characteristic data from one or more product characteristic sensors associated with the aggregate processing system; and
processing said collected product characteristic data with algorithm logic or artificial intelligence logic.

17. The method of claim 14, further comprising:
collecting second equipment criteria data from a first equipment criteria sensor associated with the aggregate processing system; and
processing said collected second equipment criteria data with algorithm logic or artificial intelligence logic.

18. A method of controlling and monitoring an aggregate processing system, comprising:
monitoring the aggregate processing system;
varying one or more operating characteristics of the aggregate processing system;
collecting first equipment criteria data from a first equipment criteria sensor associated with the aggregate processing system;
processing said collected first equipment criteria data with algorithm logic or artificial intelligence logic;
using the algorithm logic or artificial intelligence logic, identifying one or more operational characteristic changes to increase an economic yield of the aggregate processing system; and
actuating said identified operational change.

19. The method of claim 18, further comprising:
collecting product quantity data from one or more product quantity sensors associated with the aggregate processing system; and
processing said collected product quantity with algorithm logic or artificial intelligence logic.

20. The method of claim 18, further comprising:
collecting product characteristic data from one or more product characteristic sensors associated with the system; and
processing said collected product characteristic data with algorithm logic or artificial intelligence logic.

21. The method of claim 18, further comprising:
collecting second equipment criteria data from a first equipment criteria sensor associated with the aggregate processing system; and
processing said collected second equipment criteria data with algorithm logic or artificial intelligence logic.

22. The aggregate processing system of claim 1, wherein said one or more items of aggregate processing equipment comprises a crusher.

23. The aggregate processing system of claim 22, wherein said plurality of equipment criteria sensors comprises one or more kinetic sensors disposed on one or more of a head shaft, head, bowl, housing, countershaft, or flywheel of said crusher and configured to record kinetic data during operation of said crusher.

24. The aggregate processing system of claim 22, wherein said plurality of equipment criteria sensors comprises one or more temperature sensors disposed on one or more of a head shaft, head, bowl, housing, countershaft, or flywheel of said crusher and configured to record temperature data during operation of said crusher.

25. The aggregate processing system of claim 22, wherein said plurality of equipment criteria sensors comprises one or more load sensors disposed on one or more of a head shaft, head, bowl, housing, countershaft, or flywheel of said crusher and configured to record load data during operation of said crusher.

26. The aggregate processing system of claim 22, wherein said plurality of equipment criteria sensors comprises one or more vibration sensors disposed on one or more bushings or bearings of said crusher and configured to record vibration data during operation of said crusher.

27. The aggregate processing system of claim 22, wherein said plurality of equipment criteria sensors comprises one or more vibration sensors disposed on said crusher and configured to record vibration data during operation of said crusher.

28. The aggregate processing system of claim 22, wherein at least one of said plurality of equipment criteria sensors comprises an energy consumption sensor configured to monitor an energy consumption of a drive of said crusher.

29. The aggregate processing system of claim 22, wherein at least one of said plurality of equipment criteria sensors comprises a wear sensor disposed on or adjacent to a consumable liner of said crusher and configured to monitor a wear level of said consumable liner.

30. The aggregate processing system of claim 22, wherein at least one of said plurality of equipment criteria sensors comprises a lubricant characteristic sensor comprising one of a flow sensor, viscosity sensor, or temperature sensor, said lubricant characteristic sensor in fluid communication with a lubrication system of said crusher.

31. The aggregate processing system of claim 22, wherein at least one of said plurality of product sensors comprises a camera configured to monitor aggregate material at one of a feed inlet or an outlet of said crusher.

32. The aggregate processing system of claim 22, wherein at least one of said plurality of product sensors comprises a load sensor configured to monitor an amount of aggregate material processed by said crusher.

33. The aggregate processing system of claim 22, wherein at least one of said plurality of control elements comprises a drive controller configured to modify a speed or frequency of the crusher and configured to selectively turn said crusher on or off.

34. The aggregate processing system of claim 22, wherein at least one of said plurality of control elements comprises at least a first tramp relief controller configured to selectively actuate a tramp relief system of said crusher.

35. The aggregate processing system of claim 22, wherein at least one of said plurality of control elements comprises at least a first tramp relief controller configured to selectively actuate a tramp relief system of said crusher.

36. The aggregate processing system of claim 22, wherein at least one of said plurality of control elements comprises at least a first crushing gap controller configured to selectively actuate a crushing gap adjustment system.

37. The aggregate processing system of claim 1 wherein said one or more items of aggregate processing equipment comprises a vibratory classifier.

38. The aggregate processing system of claim 37, wherein said plurality of equipment criteria sensors comprises a kinetic sensor disposed on a sidewall of said vibratory classifier.

39. The aggregate processing system of claim 37, wherein said plurality of equipment criteria sensors comprises a first kinetic sensor and second kinetic sensor, said first kinetic sensor and second kinetic sensor disposed on corresponding locations of respective first and second sidewalls of said vibratory classifier.

40. The aggregate processing system of claim 37, wherein said plurality of equipment criteria sensors comprises a load sensor disposed on or adjacent to a load-bearing component of said vibratory classifier.

41. The aggregate processing system of claim 37, wherein said plurality of equipment criteria sensors comprises a load cell disposed on a sidewall of said vibratory classifier.

42. The aggregate processing system of claim 37, wherein at least one of said plurality of equipment criteria sensors comprises an energy consumption sensor configured to monitor an energy consumption of a drive of said vibratory classifier.

43. The aggregate processing system of claim 37, wherein at least one of said plurality of equipment criteria sensors comprises a wear sensor disposed on or adjacent to classifying media of said vibratory classifier and configured to monitor a wear level of said classifying media.

44. The aggregate processing system of claim 37, wherein at least one of said plurality of equipment criteria sensors comprises a bearing operational characteristic sensor configured to monitor a bearing operational characteristic of a bearing of said vibratory classifier, said bearing operational characteristic comprising a temperature associated with said bearing or a vibration associated with said bearing.

45. The aggregate processing system of claim 37, wherein at least one of said plurality of equipment criteria sensors comprises a lubricant characteristic sensor comprising one of a flow sensor, viscosity sensor, or temperature sensor, said lubricant characteristic sensor in fluid communication with a lubrication system of said vibratory classifier.

46. The aggregate processing system of claim 37, wherein at least one of said plurality of product sensors comprises a material sensor configured to evaluate a characteristic of aggregate material at one of an upper deck or a discharge end of said vibratory classifier.

47. The aggregate processing system of claim 37, wherein at least one of said plurality of control elements comprises a drive controller configured to modify a speed or frequency of said vibratory classifier and configured to selectively turn said vibratory classifier on or off.

48. The aggregate processing system of claim 37, wherein at least one of said plurality of control elements comprises one or more actuators for modifying an angle of one or more decks of the vibratory classifier.

49. The aggregate processing system of claim 37, wherein at least one of said plurality of control elements comprises an application controller configured to modify a rate of fluid application via one or more fluid injector elements of said vibratory classifier.

50. The aggregate processing system of claim 37, wherein at least one of said plurality of control elements comprises one or more actuators for modifying an angle of one or more decks of the vibratory classifier.

51. The aggregate processing system of claim 1 wherein said one or more items of aggregate processing equipment comprises a conveyor.

52. The aggregate processing system of claim 51, wherein at least one of said plurality of product sensors comprises a material sensor configured to evaluate a characteristic of aggregate material on a belt of said conveyor.

53. The aggregate processing system of claim 51, wherein at least one of said plurality of product sensors comprises a camera configured to evaluate a visual characteristic of aggregate material on a belt of said conveyor.

54. The aggregate processing system of claim 51, wherein at least one of said plurality of product sensors comprises a load sensor configured to measure a weight of aggregate material on a belt of said conveyor.

55. The aggregate processing system of claim 51, wherein at least one of said plurality of equipment criteria sensors comprises an energy consumption sensor configured to monitor an energy consumption of a drive of said conveyor.

56. The aggregate processing system of claim 51, wherein at least one of said plurality of equipment criteria sensors comprises a bearing temperature sensor associated with a bearing of one of an idler or a pulley of said conveyor.

57. The aggregate processing system of claim 51, wherein at least one of said plurality of equipment criteria sensors comprises a load sensor associated with a shaft of one of an idler or a pulley of said conveyor.

58. The aggregate processing system of claim 51, wherein at least one of said plurality of equipment criteria sensors comprises a vibration sensor associated with one of an idler or a pulley of said conveyor.

59. The aggregate processing system of claim 51, wherein at least one of said plurality of equipment criteria sensors comprises a rotational speed sensor associated with one of an idler or a pulley of said conveyor.

60. The aggregate processing system of claim 51, wherein at least one of said plurality of equipment criteria sensors comprises an embedded sensor embedded in a lagging of a pulley of said conveyor, said embedded sensor configured to measure one of a temperature of said lagging, a load on said lagging, or a wear of said lagging.

61. The method of claim 14, wherein the aggregate processing system comprises a crusher, wherein said varying one or more operating characteristics of the aggregate processing system comprises varying an operating speed of the crusher.

62. The method of claim 14, wherein the aggregate processing system comprises a crusher, wherein varying one or more operating characteristics of the aggregate processing system comprises varying a crushing gap of the crusher.

63. The method of claim 14, wherein the aggregate processing system comprises a vibratory classifier, wherein said varying one or more operating characteristics of the aggregate processing system comprises varying an operating speed of the vibratory classifier.

64. The method of claim 14, wherein the aggregate processing system comprises a vibratory classifier, wherein said varying one or more operating characteristics of the aggregate processing system comprises varying an angle of a classifying deck of the vibratory classifier.

65. The method of claim 14, wherein the aggregate processing system comprises a conveyor, wherein said varying one or more operating characteristics of the aggregate processing system comprises varying an operating speed of the conveyor.

66. The method of claim 18, wherein the aggregate processing system comprises a crusher, wherein said varying one or more operating characteristics of the aggregate processing system comprises varying an operating speed of the crusher.

67. The method of claim 18, wherein the aggregate processing system comprises a crusher, wherein said varying one or more operating characteristics of the aggregate processing system comprises varying a crushing gap of the crusher.

68. The method of claim 18, wherein the aggregate processing system comprises a vibratory classifier, wherein said varying one or more operating characteristics of the aggregate processing system comprises varying an operating speed of the vibratory classifier.

69. The method of claim 18, wherein the aggregate processing system comprises a vibratory classifier, wherein said varying one or more operating characteristics of the aggregate processing system comprises varying an angle of a classifying deck of the vibratory classifier.

70. The method of claim 18, wherein the aggregate processing system comprises a conveyor, wherein said varying one or more operating characteristics of the aggregate processing system comprises varying an operating speed of the conveyor.
